(19) United States
(12) Patent Application Publication
(10) Pub. No.: US 2003/0110794 A1
(43) Pub. Date: Jun. 19, 2003

(54) Soil remediation well positioning in relation to curved obstructions

(76) Inventors: George L. Stegemeier, Houston, TX (US); Harold J. Vinegar, Bellaire, TX (US)

Correspondence Address: ERIC B. MEYERTONS, CONLEY, ROSE & TAYON, P.C., P.O. BOX 398, AUSTIN, TX, 78767-0398, US

(21) Appl. No.: 10/280,103

(22) Filed: Oct. 24, 2002

Related U.S. Application Data
(60) Provisional application No. 60/343,969, filed on Oct. 24, 2001.

(51) Int. Cl. B09B 1/00; B09C 1/00; G21F 9/00

(52) U.S. Cl. 62/531; 405/128.1; 405/128.3; 405/128.15

(57) ABSTRACT

A soil remediation system, such as an in situ thermal desorption system, may be used to treat contaminated soil in a treatment area with an arcuate obstruction in the treatment area. A pattern of wells may be positioned to avoid placing a well in a wall of the obstruction. The well pattern may be oriented based upon the center of the obstruction. A well of the well pattern may be placed at the center of the obstruction. Alternatively, the center of the obstruction may be positioned at a centroid of a unit of the well pattern, or at the midpoint of a side of a unit of the well pattern. The well pattern may be a regular pattern that is positioned so that the arcuate obstruction is placed within a large gap between adjacent orbitals (or rings) of the regular well pattern.

### PRIORITY CLAIM

This application claims priority to U.S. Provisional Application No. 60/343,969 entitled “Soil Remediation Well Positioning In Relation To Curved Obstructions,” filed Oct. 24, 2001. The above-referenced provisional application is hereby incorporated by reference as if fully set forth herein.

### BACKGROUND OF THE INVENTION

1. Field of the Invention

The present invention relates generally to soil remediation. An embodiment of the invention relates to well pattern placement for avoiding substantially curved obstructions in a region of contaminated soil.

2. Description of Related Art

Contamination of soil has become a matter of concern in many locations. “Soil” refers to unconsolidated and consolidated material in the ground. Soil may include natural formation material such as dirt, sand, and rock, as well as other material, such as fill material. Soil may become contaminated with chemical, biological, and/or radioactive contaminants. Contamination of soil may occur in a variety of ways, such as material spillage, leakage from storage vessels, and landfill seepage. Additional public health concerns arise if the contaminants migrate into aquifers or into air. Soil contaminants may also migrate into the food supply through bioaccumulation in various species in a food chain.

There are many methods to remediate contaminated soil. “Remediating soil” means treating the soil to remove soil contaminants or to reduce contaminants within the soil (e.g., to acceptable levels). A method of remediating a contaminated site is to excavate the soil and to process the soil in a separate treatment facility to eliminate or reduce contaminant levels within the soil. Many problems associated with this method may limit its use and effectiveness. For example, dust generation that accompanies excavation exposes the surrounding environment and workers to the soil contamination. Also, many tons of soil may need to be excavated to effectively treat even a small contamination site. Equipment, labor, transport, and treatment costs may make the method prohibitively expensive compared to other soil remediation methods.

Biological treatment and in situ chemical treatment may also be used to remediate soil. Biological and/or chemical treatment may involve injecting material into the soil, such that the material reacts and/or moves contamination within the soil. A material injected during a biological or chemical treatment may be a reactant configured to react with the soil contamination to produce reaction products that are not contaminated. Some of the reaction products may be volatile. These reaction products may be removed from the soil.

The material injected during a chemical treatment may be a drive fluid configured to drive the contamination toward an extraction well that removes the contaminant from the soil. The drive fluid may be steam, carbon dioxide, or other fluid. Soil heterogeneity and other factors may, however, inhibit uniform reduction of contaminant levels in the soil using biological treatment and/or chemical treatment. Furthermore, fluid injection may result in migration of contaminants into adjacent soil.

Soil vapor extraction (SVE) is a process that may be used to remove contaminants from subsurface soil. During SVE, some vacuum is applied to draw air through the subsurface soil. Vacuum may be applied at a soil/air interface or through vacuum wells placed within the soil. The air may entrain and carry volatile contaminants towards the vacuum source. Off-gas removed from the soil by the vacuum may include contaminants that were within the soil. The off-gas may be transported to a treatment facility. The off-gas removed from the soil may be processed in the treatment facility to eliminate or reduce contaminants within the off-gas. SVE may allow contaminants to be removed from soil without the need to move or significantly disturb the soil. For example, SVE may be performed under roads, foundations, and other fixed structures.

Permeability of subsurface soil may limit the effectiveness of SVE. Air and vapor may flow through subsurface soil primarily through high permeability regions of the soil. The air and vapor may bypass low permeability regions of the soil, allowing relatively large amounts of contaminants to remain in the soil. Areas of high and low permeability may be characterized by, for example, moisture, stratified soil layers, and fractures and material heterogeneities within the soil.

Water may be present within soil. At a certain level within some soil, pore spaces within the soil become saturated with water. This level is referred to as the saturation zone. In the vadose zone, above the saturation zone, pore spaces within the soil are filled with water and gas. The interface between the vadose zone and the saturated zone is referred to as the water table. The depth of the water table refers to the depth of the saturated zone. The saturated zone may be limited by an aquitard. An aquitard is a low permeability layer of soil that inhibits migration of water.

Reduced air permeability due to water retention may inhibit contact of flowing air with contaminants in the soil during SVE soil remediation. Dewatering the soil may partially solve the problem of water retention. The soil may be dewatered by lowering the water table and/or by using a vacuum dewatering technique. These methods may not be effective methods of opening the pores of the soil to admit airflow. Capillary forces may inhibit removal of water from the soil when the water table is lowered. Lowering the water table may result in moist soil, which may limit air conductivity.

A vacuum dewatering technique may have practical limitations. The vacuum generated during a vacuum dewatering technique may diminish rapidly with distance from the dewatering wells. The use of vacuum dewatering may not significantly decrease water retention in the soil. This method may also result in the formation of preferential passageways for air conductivity located adjacent to the dewatering wells.

Many types of soil are characterized by horizontal layering with alternating layers of high and low permeability. A common example of a layered type of soil is lacustrine sediments, characterized by thin beds of alternating silty and sandy layers. Attempts to conduct SVE in such layers results in airflow that occurs substantially within the sandy layers and bypasses the silty layers.

Heterogeneities may be present in soil. Air and vapor may preferentially flow through certain regions or layers of heterogeneous soil, such as gravel beds. Air and vapor may be impeded from flowing through other regions or layers of heterogeneous soil, such as clay beds. Also, for example, air and vapor tend to flow preferentially through voids in poorly compacted fill material. Air and vapor may be impeded from flowing through overly compacted fill material. Buried debris within fill material may also impede the flow of air through soil.

Some components of soil contamination may be toxic. Such soil contamination may include mercury, mercury-containing compounds such as dimethyl mercury, radioactive materials such as plutonium, volatile hazardous compounds, and combinations thereof. Placement of wells or use of invasive testing procedures to identify the location and extent of the soil contamination may require special measures to ensure that the surrounding environment and workers are not exposed to contaminated vapor, dust, or other forms of contamination during installation and use of the wells or testing procedures. Such measures may include, but are not limited to, placing dust or vapor producing operations within enclosures to prevent release of contaminants to the environment, treating air within such enclosures to remove or reduce contamination before releasing the air to the environment, equipping workers with appropriate protective clothing, and/or equipping workers with appropriate breathing filters or separate source air supplies.

In some cases, removal of some contaminants from affected soil may be impractical, but removal of other contaminants may be desirable. For example, soil that is contaminated with radioactive material may also be contaminated with other contaminants such as mercury, mercury-containing compounds, and/or chlorinated hydrocarbons. Removal of the radioactive material may be impossible or impractical, but it may be desirable to remove or reduce other contaminants within the soil to inhibit such contamination from migrating to other areas through the soil.

The presence of water within the ground is often a problem for construction projects. The problem of water presence and/or water recharge may have to be overcome for some construction projects. A barrier to water migration into a selected area may be established by forming a freeze wall surrounding the selected area. The use of freeze walls to stabilize soil adjacent to a work site and to inhibit water migration into the work site has been implemented during construction of tunnels and shafts and during excavation work. In a typical application of freeze wells at a work site, freeze wells are inserted into the soil and a wall of frozen water and soil is formed around a selected area. The soil within the selected area is then excavated to form a hole. Supports may prevent the walls defining the hole from falling in. The freeze wall may be allowed to thaw when sufficient support is installed to prevent collapse of the walls. Alternatively, work within the hole formed by the removal of the soil may be completed relying on the frozen wall of water and soil to prevent the hole from collapsing. The frozen wall of water and soil may be allowed to thaw after completion of the work within the well.

U.S. Pat. No. 2,777,679 issued to Ljungström, which is incorporated by reference as if fully set forth herein, describes creating a frozen barrier to define a perimeter of a zone that is to be subjected to hydrocarbon production. Material within the zone is pyrolyzed by convectively advancing a heating front through the material to drive pyrolysis products towards production wells. U.S. Pat. No. 4,860,544 issued to Krieg et al., which is incorporated by reference as if fully set forth herein, describes establishing a closed cryogenic barrier confinement system about a predetermined volume extending downward from or beneath a surface region of Earth, i.e., a containment site.

An obstruction may be present in soil that is to be remediated. A perimeter of the obstruction may include an arcuate edge. For example, a gas holder of a manufactured gas plant may be located within a region of contaminated soil. The gas holder may be a circular masonry or concrete wall that is about two feet thick, 50 to 100 feet in diameter, and 10 to 20 feet deep. The gas holder may contain contaminated soil, and soil adjacent to the gas holder may also be contaminated. The placement of wells within a contaminated region of soil may be problematic when an obstruction that has an arcuate perimeter edge is located within the soil. Regularly spaced wells provide the means for efficient distribution of heat. Regularly spaced well locations, however, frequently occur in the perimeter wall. Placing wells of a soil remediation system in a perimeter edge of an obstruction may be costly, time consuming, and undesirable. Significantly altering a pattern of wells to avoid drilling into an obstruction may result in patterns of heating that leave poorly heated regions most distant from heaters.

### SUMMARY

An obstruction that has an arcuate perimeter edge may be located within a region of contaminated soil. A soil remediation system may be used to treat the soil to reduce or eliminate the soil contamination. The soil remediation system may include a number of wells that are placed in the soil. The wells may be placed in a substantially regular pattern that allows uniform treatment, yet such that the wells do not impinge upon the obstruction. A radial center of a curved edge of the obstruction may be used as a reference point for establishing the pattern of wells within the soil. The well pattern may be chosen to avoid placing wells in the obstruction. The well pattern may be chosen so that there is minimal deviation from a regular well pattern. Maintaining regular well patterns may be important in attaining complete treatment of a target volume in a timely manner. The well pattern may also allow for a dense grouping of wells on an interior side of the arcuate edge of the obstruction and/or a dense grouping of wells on an exterior side of the arcuate edge of the obstruction.

Wells may be placed in contaminated soil in rows and columns. The rows and columns of wells are typically arranged so that the wells form a pattern of triangles or rectangles. Preferably, a unit of the well pattern is an equilateral triangle or a square with a well located at each corner of the triangle or square. An equilateral triangle well pattern may be preferred over a square well pattern because the triangle well pattern may allow for more uniform vapor removal and/or soil heating throughout an area of contaminated soil. The distance from a well to a center of a unit of an equilateral triangle well pattern is 0.5774 (or 1/√3) times the length of a side of the triangle. The distance from a well to a center of a unit of a square well pattern is 0.7071 (or 1/√2) times the length of a side of the square. For an equilateral triangle well pattern wherein the length of a side of the triangle is the same as the length of a side of a square well pattern, the shorter distance between a well and the center of a unit for the equilateral triangle well pattern may allow the soil to heat more uniformly when heater wells are arranged in the equilateral triangle well pattern. If the wells of the unit pattern are extraction wells, the shorter distance from a well to the center of a unit for a triangle pattern may allow for more uniform vapor flow throughout a contaminated volume of soil between adjacent extraction wells.

Wells that are positioned within an area that includes an arcuate obstruction may be located in orbits around a central point. The central point may be a radial center of curvature of a circular obstruction. A circular orbit is at a radial distance from a center of the obstruction to a center of a well. A pattern of wells may be a center well pattern, a center unit pattern, or a center side pattern, depending on the position of wells in the pattern relative to the radial center of curvature of the obstruction. Wells may be located at or near the radial center of curvature of the obstruction (depending on the type of pattern), or imaginary wells may be located at or near the radial center of curvature of the obstruction. Imaginary wells may be utilized when a soil treatment area does not extend or include an area near the radial center of curvature of the obstruction.

A center well pattern may be based on a well, or an imaginary well, located substantially at a radial center of curvature of an obstruction. A center well pattern may be a center well equilateral triangle pattern (also referred to as a center well triangle pattern), a center well square pattern, or a center well higher order polygon pattern, in which the polygon has more than four sides.

A center unit pattern is a pattern in which a centroid of a unit, or a centroid of an imaginary unit, is positioned substantially at a radial center of curvature of an obstruction. A center unit pattern may be a center unit equilateral triangle pattern (also referred to as a center unit triangle pattern), a center unit square pattern, or a center unit polygon pattern, in which the polygon has more than four sides.

A center side pattern is a pattern in which a midpoint of a side of a unit, or an imaginary unit, is positioned substantially at a radial center of curvature of an obstruction. A center side pattern may be a center side equilateral triangle pattern, a center side square pattern, or a center side polygon pattern, in which the polygon has more than four sides.

A distance or gap between two adjacent orbits may be large for selected orbits of certain well patterns. A large distance between orbits may be greater than about 0.30 times a length of a side of a well unit. A large distance between adjacent orbits may allow wells to be positioned so that the wells do not impinge upon an arcuate obstruction located in a soil treatment area. For example, for a center well equilateral triangle pattern, the distance between the second and third orbits is 0.268 times a length of a side of a well unit, while the distance between the third and fourth orbits is 0.646 times the length of the side of the well unit. Choosing a length of the side of the well pattern so that the arcuate obstruction is located between the third and fourth orbits may allow for easier placement of the wells to avoid the obstruction than if the length of the side of the well pattern were chosen so that the obstruction is located between the second and third orbits.

For center well triangle patterns, a large distance to the next orbit is present after orbits 1, 3, 4, 5, 7, 8, 10, 14, 17, 18, 21, etc. For center well square patterns, a large distance to the next orbit is present after orbits 1, 2, 4, 7, 8, 12, 21, 26, etc. For center unit triangle patterns, a large distance to the next orbit is present after orbits 1, 2, 3, 6, 9, 13, 19, etc. For center unit square patterns, a large distance to the next orbit is present after orbits 1, 2, 3, 4, 5, 7, 12, 14, 15, 25, 30, etc.

Orbits of a well pattern may have different numbers of wells. For example, for a center well equilateral triangle pattern, the number of wells in the third orbit is six, and the number of wells in the fourth orbit is twelve. If a well pattern requires that a number of wells be moved to avoid an arcuate obstruction, the orbit that would intersect the obstruction may be chosen so that the orbit has a small number of wells. The small number of wells may be repositioned with minimal disruption of the regular well pattern. A large gap may be formed by moving wells of two adjacent orbits outward and inward. The wells in the outer orbit may be moved radially outward, and the wells of the inner orbit may be moved radially inward. For example, for a center side equilateral triangle pattern, there is a gap 0.221 times a length of a side of a unit between the thirteenth and fourteenth orbits, and a gap 0.275 times the length of the side of the unit between the fourteenth and fifteenth orbits. The four wells in the thirteenth orbit may be moved radially inward or eliminated, and the six wells in the fourteenth orbit may be moved radially outward or eliminated to form a large gap (up to about 0.50 times the length of the side of a unit) that may accommodate an arcuate obstruction.

Wells may be placed within a region of contaminated soil that includes an arcuate obstruction. The wells may be placed in a regular pattern of rows and columns with minimal deviations from the regular pattern if the wells are properly positioned relative to a center of the obstruction. The pattern may be chosen so that the arcuate obstruction is located in a large gap between two adjacent well orbits. If necessary to avoid contacting the arcuate obstruction, some wells may be moved from the regular pattern. A well pattern may be chosen so that an orbit that has only a few wells that contact the circular obstruction impinges upon the circular obstruction. The wells of the orbit that impinge upon the circular obstruction may be moved to avoid having to place wells in a wall of the obstruction.

### BRIEF DESCRIPTION OF THE DRAWINGS

Advantages of the invention will become apparent upon reading the following detailed description and upon reference to the accompanying drawings in which:

FIG. 1 shows a top view of an area of soil contamination including a circular obstruction within the contaminated area.

FIG. 2 shows a schematic diagram of an in situ thermal desorption soil remediation system.

FIG. 3 shows a top view of a unit of an equilateral triangle well pattern.

FIG. 4 shows a top view of a unit of a square well pattern.

FIG. 5 shows a top view of a center well equilateral triangle pattern with orbits shown in hidden lines.

FIG. 6 shows a top view of a center well square pattern with orbits shown in hidden lines.

FIG. 7 shows a top view of a center unit equilateral triangle pattern with orbits shown in hidden lines.

FIG. 8, shows a top view of a center unit square pattern with orbits shown in hidden lines.

FIG. 9 shows a top view of a center side equilateral triangle pattern with orbits shown in hidden lines.

FIG. 10 shows a top view of a center side square pattern with orbits shown in hidden lines.

FIG. 11 shows a top view of a center well equilateral triangle pattern with a circular obstruction located substantially between the seventh and eighth orbits of the well pattern, and with the wells of the eighth orbit moved radially outward to avoid placing the wells of the eighth orbit within the obstruction wall.

FIG. 12 shows a top view of a center well square pattern with an arcuate obstruction located between the seventh and eighth orbits of the well pattern.

FIG. 13 shows a top view of a center well equilateral triangle pattern with two different types of wells included in the pattern.

FIG. 14 shows a top view of a center well equilateral triangle pattern with two different types of wells included in the pattern.

FIG. 15 shows a top view of a center well equilateral triangle pattern wherein contaminated soil is located on outer side of an obstruction.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE PREFERRED EMBODIMENTS

An in situ thermal desorption (ISTD) process system may be used to remediate contaminated soil. An ISTD soil remediation process involves in situ heating of the soil to raise the temperature of the soil while simultaneously removing off-gas by vacuum. Heating the soil may result in removal of contaminants by a number of mechanisms. Such mechanisms may include, but are not limited to: vaporization and vapor transport of the contaminants from the soil; evaporation or entrainment and removal of contaminants into an air or water vapor stream; and/or thermal degradation or conversion of contaminants into non-contaminant compounds by pyrolysis, oxidation, or other chemical reactions within the soil.

An ISTD soil remediation process may offer significant advantages over soil vapor extraction (SVE) processes and processes that depend on the injection of drive fluids, chemical reactants, and/or biological reactants into the soil. Fluid flow conductivity of an average soil may vary by a factor of 10⁸ throughout the soil due in part to soil heterogeneities and water within the soil. As used herein, “fluid” refers to matter that is in a liquid or gaseous state. Mass transport of fluid through the soil may be a limiting factor in the remediation of a treatment site using an SVE process or a chemical and/or biological treatment of the soil. In contrast to the extremely large variation in fluid flow permeability of soil, thermal conductivity of an average soil may vary by a factor of only about two throughout the soil. Injecting heat into soil may be significantly more effective than injecting a fluid through the same soil. Furthermore, injecting heat into soil may result in a preferential increase in the permeability of tight (low permeability) soil. Injected heat may dry the soil. As the soil dries, microscopic and macroscopic permeability of the soil may increase. The increase in permeability of heated soil may allow an ISTD soil remediation process to remove or reduce contaminants to acceptable levels throughout a treatment area. The increase in soil permeability may allow in situ remediation of low permeability clays and silts that are not amenable to standard soil vapor extraction processes.

U.S. patent application Ser. No. ______, entitled “Thermally Enhanced Soil Decontamination Method” to Stegemeier et al. and filed on Oct. 24, 2002; “Isolation Of Soil With A Frozen Barrier Prior To Conductive Thermal Treatment Of The Soil” to Vinegar et al. and filed on Oct. 24, 2002; and U.S. patent application Ser. No. ______, entitled “Soil Remediation of Mercury Contamination” to Vinegar et al. and filed on Oct. 24, 2002 describe ISTD soil remediation processes. Each of these references is incorporated by reference as if fully set forth herein.

In a soil remediation embodiment, a method of decontamination includes heating the contaminated soil to temperatures at which the contaminants are removed by vaporization and/or thermal destruction. In situ water may vaporize and steam distill or entrain contaminants. The contaminants in the water vapor may be removed from the soil through extraction wells.

Soil may be heated by a variety of methods. Methods for heating soil include, but are not limited to, heating by thermal radiation or conduction from a heat source, heating by radio frequency heating, or heating by electrical soil resistivity heating. “Radiative heating” refers to radiative heat transfer from a hot source to a colder surface. In the ISTD process, heat is then transferred primarily by conduction from the heated soil surface to adjacent soil, thereby raising the soil temperature at some distance from the heat source. Radiative and/or conductive heating may be advantageous because temperatures obtainable by such heating are not limited by the amount of water present in the soil. Soil temperatures substantially above the boiling point of water may be obtained using radiative and/or conductive heating. Soil temperatures of about 100° C., 125° C., 150° C., 200° C., 400° C., 500° C., or greater may be obtained using thermal radiative and/or conductive heating. The heat source for radiative and/or conductive heating may be, but is not limited to, an electrical resistance heater placed in a wellbore, a heat transfer fluid circulated through a wellbore, or combustion within a wellbore.

Heaters may be placed in or on the soil to heat the soil. For soil contamination within about 1 m of the soil surface, thermal blankets and/or ground heaters placed on top of the soil may apply conductive heat to the soil. A vacuum system may draw a vacuum on the soil through vacuum ports that pass through the thermal blanket. The heaters may operate at about 870° C. U.S. Pat. No. 5,221,827 issued to Marsden et al., which is incorporated by reference as if fully set forth herein, describes a thermal blanket soil remediation system. U.S. Pat. No. 4,984,594 issued to Vinegar et al., which is incorporated by reference as if fully set forth herein, describes an in-situ method for removing contaminants from surface and near-surface soil by imposing a vacuum on the soil beneath a impermeable flexible sheet and then heating the soil with an electric surface heater that is positioned on the soil surface under the sheet.

For deeper contamination, heater wells may be used to supply heat to the soil. U.S. Pat. No. 5,318,116 and U.S. patent application Ser. No. 09/549,902 to Vinegar et al. and U.S. patent application Ser. No. 09/836,447 to Vinegar et al., each of which is incorporated by reference as if fully set forth herein, describe ISTD soil remediation processes for treating contaminated subsurface soil with radiative and/or conductive heating. U.S. patent application Ser. No. 09/841,432 to Wellington et al.; U.S. patent application Ser. No. 10/131,123 to Wellington et al.; and U.S. patent application Ser. No. ______, entitled “In Situ Recovery From A Hydrocarbon Containing Formation Using Barriers” to Wellington et al. and filed on Oct. 24, 2002, also describe heaters and various equipment. Each of these applications is incorporated by reference as if fully set forth herein.

Some heater wells may include perforated casings that allow fluid to be removed from the soil. A heater well with a perforated casing may also allow fluid to be drawn or injected into the soil. Vacuum may be applied to the soil to draw fluid from the soil. The vacuum may be applied at the surface or through extraction wells placed within the soil.

The term “wells” refers to heater wells, production or extraction wells, injection wells, and test wells. Soil temperature may be raised using heater wells. Fluid from the soil may be withdrawn from the soil through extraction wells. Some extraction wells may include heater elements. Such extraction wells, also referred to as “heater-extraction wells” are capable of both raising soil temperature and removing fluid from the soil. In a region adjacent to a heater-extraction well, heat flow may be countercurrent to fluid flow. Fluid withdrawn from the heater-extraction well may be exposed to a high enough temperature within the heater-extraction well to result in the destruction of some of the contaminants within the fluid. Injection wells allow a fluid to be inserted into the soil. Sampling or logging of the soil or fluid from the soil may be performed using test wells that are positioned at desired locations within a well pattern of a soil remediation system.

An in situ soil remediation system may include a plurality of heater wells and at least one vapor extraction well. A vapor extraction well may also include one or more heater elements. Heater-vapor extraction well heater elements may provide heat for establishing an initial permeability in the vicinity of the vapor extraction well. The additional heat may also prevent condensation of water vapor and contaminants in the well. In some extraction well embodiments, the extraction wells may not include heater elements. Absence of heater elements within the vapor extraction well may simplify the design of the vapor extraction wellbore, and may be preferred in some applications.

Wells may be arranged in a pattern of rows and columns within the soil. Rows of wells may be staggered so that the wells are in a triangle pattern. Alternatively, the wells may be aligned in a rectangle pattern, pentagon pattern, hexagon pattern, or higher order polygon pattern. A distance between adjacent wells may be a substantially fixed distance so that a polygon well pattern may be made up of regular arrays of equilateral triangles or squares. A spacing distance between adjacent wells of a pattern may range from about 1 m to about 12 m or more. A typical spacing distance may be from about 2 m to 4 m. Some wells may be placed out of a regular pattern to avoid obstructions within the pattern.

An ISTD soil remediation process may have several advantages over an SVE process. Heat added to the contaminated soil may raise the temperature of the soil above the vaporization temperatures of contaminants within the soil. If the soil temperature exceeds the vaporization temperature of a soil contaminant, the contaminant may vaporize. Vacuum applied to the soil may be able to draw the vaporized contaminant out of the soil. Even heating the soil to a temperature below vaporization temperatures of the contaminants may have beneficial effects. Increasing the soil temperature may increase vapor pressures of the contaminants in the soil and allow an air stream to remove a greater portion of the contaminants from the soil than is possible at lower soil temperatures. Increased permeability of the soil due to heating may allow removal of contaminants throughout a soil treatment area.

Many soil formations include a large amount of water as compared to contaminants. Raising the temperature of the soil to the vaporization temperature of water may vaporize the water. The water vapor may help volatize (by steam distillation) and/or entrain contaminants within the soil. Vacuum applied to the soil may remove the volatized and/or entrained contaminants from the soil. Vaporization and entrainment of contaminants may result in the removal of medium and high boiling point contaminants from the soil.

In addition to allowing greater removal of contaminants from the soil, the increased heat of the soil may result in the destruction of contaminants in situ. The presence of an oxidizer, such as air or water vapor, may result in the oxidation of the contaminants that pass through high temperature soil. In the absence of oxidizers, contaminants within the soil may be altered by pyrolysis. Vacuum applied to the soil may remove reaction products from the soil.

A heating and vapor extraction system may include heater wells, extraction wells, injection wells, and/or test wells. Heater wells apply thermal energy to the soil to increase soil temperature. Extraction wells of a heating and vapor extraction system may include perforated casings that allow off-gas to be removed from the soil. The casing or a portion of the casing may be made of a metal that is resistant to chemical and/or thermal degradation. Perforations in a well casing may be plugged with a removable material prior to insertion of the casing into the ground. After insertion of the casing into the ground, the plugs in the perforations may be removed. U.S. patent application Ser. No. 09/716,366, which is incorporated by reference as if fully set forth herein, describes wells that are installed with removable plugs placed within perforations of the well casings. Perforations in a well casing may be, but are not limited to, holes and/or slots. The perforations may be screened. The casing may have several perforated zones at different positions along a length of the casing. When the casing is inserted into the soil, the perforated zones may be located adjacent to contaminated layers of soil. The areas adjacent to perforated sections of a casing may be packed with gravel or sand. The casing may be sealed to the soil adjacent to non-producing soil layers to inhibit migration of contaminants into uncontaminated soil.

Certain regions of contaminated soil may include structures that are to be avoided when wells of a soil remediation system are placed within the region. Such structures are referred to as “obstructions.” Obstructions may be natural structures or man-made structures. An example of a natural obstruction is an area of impermeable rock within the soil. A man-made obstruction may be a legal entity, such as a property line; or a physical structure, such as a straight or curved wall or edge. A curved wall or edge may be a circular arc that includes a radial center point. In some situations, an obstruction may be a buried wall of a storage vessel or other structure, e.g., a wall of a storage tank at a manufactured gas plant. An obstruction may be defined by a perimeter. Contaminated soil may be located within the perimeter, outside of the perimeter, or both inside and outside of the perimeter.

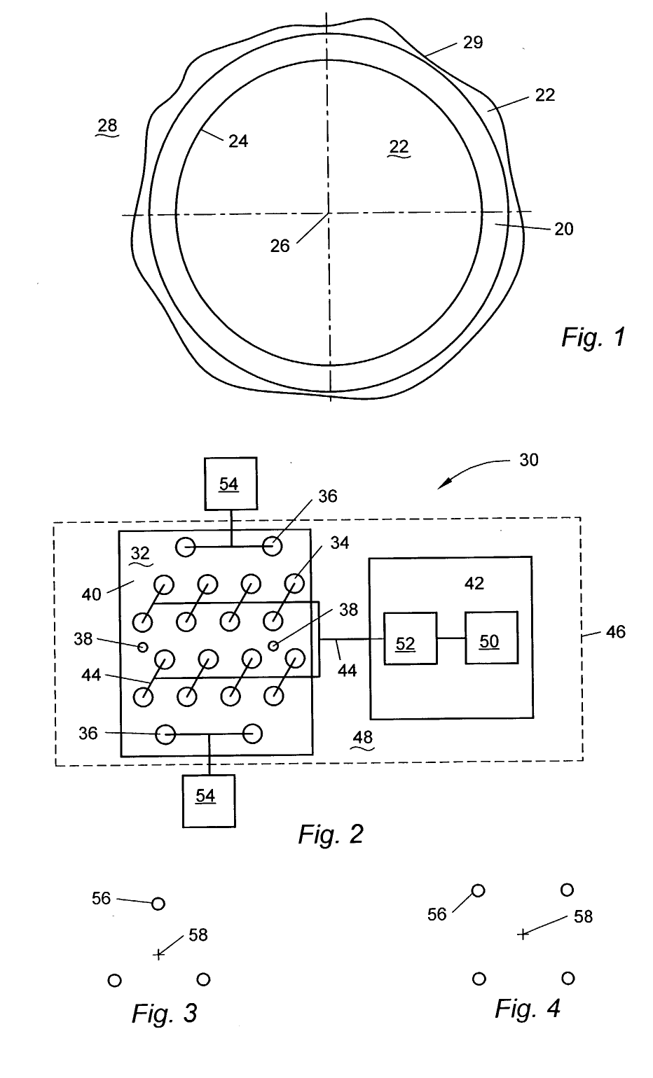

As shown in FIG. 1, obstruction 20 may be located within a region of contaminated soil 22. At least a portion of obstruction 20 may include a curved wall or edge 24. Obstruction 20 may be, but is not limited to, a retention wall, a tank or vessel, a region of impermeable soil, a pipe, or a property line. In some situations, contaminated soil 22 may be located on a side of the obstruction towards center 26 of curved wall 24. In some situations, contaminated soil 22 may be located on a side of obstruction 20 away from center 26 of curved wall 24. In other situations, contaminated soil 22 may be located on both sides of obstruction 20. Uncontaminated soil 28 may surround the area of contaminated soil 22. FIG. 1 shows circular obstruction 20 with center 26 located within a region of contaminated soil 22. An interface between contaminated soil and uncontaminated soil is designated as reference numeral 29.

FIG. 2 depicts a schematic diagram of an embodiment of soil remediation system 30. Soil remediation system 30 may be used to remove or reduce the amount of contamination within soil 32. Soil remediation system 30 may be, but is not limited to, a soil vapor extraction system or an in situ thermal desorption (ISTD) remediation system. Soil remediation system 30 may include one or more extraction wells 34. Soil remediation system 30 may optionally include one or more injection wells 36, and one or more test wells 38. Injection wells 36 and/or test wells 38 may be located inside or outside of a pattern of extraction wells 34. Wells 34, 36, 38 may be placed in augered holes within soil 32, driven into the soil, vibrated into the soil, or inserted into the soil using a combination of insertion methods.

Soil remediation system 30 may include optional ground cover 40, treatment facility 42, vapor collection system 44, and control system 46. Ground cover 40 may be placed over wells to inhibit heat loss (in an ISTD soil remediation system) and to prevent undesired contaminant vapor loss to the atmosphere. Ground cover 40 may also inhibit excess air from being drawn into soil 32. Ground cover 40 for an ISTD soil remediation system may include a layer of insulation to inhibit heat loss. Ground cover 40 may include a layer that is impermeable to contaminant vapor and/or air. Ground cover 40 may not be needed if the contamination is so deep within soil 32 that heating the soil and removing off-gas from the soil will have negligible effect at ground surface 48 of the soil. In some embodiments, the ground cover may include a metal sheet layer. Wells may be placed through the metal sheet. The wells may be welded or otherwise sealed to the metal sheet.

Treatment facility 42 may include vacuum system 50 that draws off-gas from soil 32. Treatment facility 42 may also include contaminant treatment system 52 for treating contaminants within the off-gas. Contaminant treatment system 52 may eliminate contaminants from the off-gas stream, or the contaminant treatment system may reduce the contaminants to acceptable levels. Contaminant treatment system 52 may include, but is not limited to, a reactor system, such as a thermal oxidation reactor; a mass transfer system, such as activated carbon beds; or a combination of reactor systems and mass transfer systems.

Vapor collection system 44 may include a piping system that transports off-gas removed from soil 32 to treatment facility 42. The piping system may be coupled to vacuum system 50 and to extraction wells 34. In an embodiment, the piping is thermally insulated and heated. The insulated and heated piping inhibits condensation of off-gas within the piping. In alternative embodiments, the piping may be un-heated piping and/or un-insulated piping.

Control system 46 may be a computer control system. Control system 46 may monitor and control the operation of treatment facility 42, heated vapor collection system 44, and a plurality of extraction wells 34. Control system 46 may monitor and control power input into heater elements within extraction wells 34 or injection wells 36.

Some soil remediation facilities 30 may apply heat to soil 32. Thermal energy may be supplied to soil 32 by, but is not limited to being supplied by, a radio frequency heating system, an electrical soil resistivity heating system, or a thermal conduction system. In an embodiment of an electrical soil resistivity heating system, electrical current may be supplied to the soil through a well casing.

Soil remediation system 30 may include injection wells 36. Injection wells 36 may use pumps 54 to force material into soil 32. Alternatively, fluids may be drawn into soil 32 through injection well 36 by vacuum imposed at a separate location. Injection wells 36 may also be controlled by control system 46. The material introduced into soil 32 may be a heat source (such as steam), a reactant, a solvent, or a drive fluid that pushes formation fluid towards extraction well 34. The reactant may be an oxidant. The oxidant may be, but is not limited to, air, oxygen, and/or hydrogen peroxide.

Extraction and injection wells 34, 36 may be placed in the soil in a pattern of rows and columns. The wells may be aligned so that the wells are oriented in a rectangle pattern. Alternatively, the wells may be staggered so that the wells are oriented in a triangle pattern. Preferably, a distance between adjacent wells is a constant length so that a rectangle well pattern is a square well pattern and a triangle well pattern is an equilateral triangle well pattern. A spacing distance between two adjacent wells may range from about 3 feet to about 40 feet or more. In embodiments, well spacings may range from about 5 feet to about 20 feet, and in an embodiment, the well spacing may be between about 6 feet and about 7 feet. Test wells 38 may be located at selected positions within a well pattern.

FIG. 3 shows a unit of an equilateral triangle well pattern, and FIG. 4 shows a unit of a square well pattern. A distance between wells 56 (typically extraction wells and/or injection wells) and centroid 58 of a pattern may be calculated based on trigonometry. The distance from a well to centroid 58 for an equilateral triangle well pattern is equal to 1/√3 times a length of a side of the pattern, or 0.5774 times the length of the side of the pattern. The distance from well 56 to centroid 58 for a square well pattern is equal to 1/√2 times a length of a side of the pattern, or 0.7071 times the length of the side of the pattern. For a triangle pattern and a square well pattern that have equivalent side lengths, the shorter distance between well 56 and centroid 58 of the equilateral triangle well pattern may allow more uniform heat transfer and/or mass transfer throughout a volume of soil with wells at the apexes of a unit of the pattern.

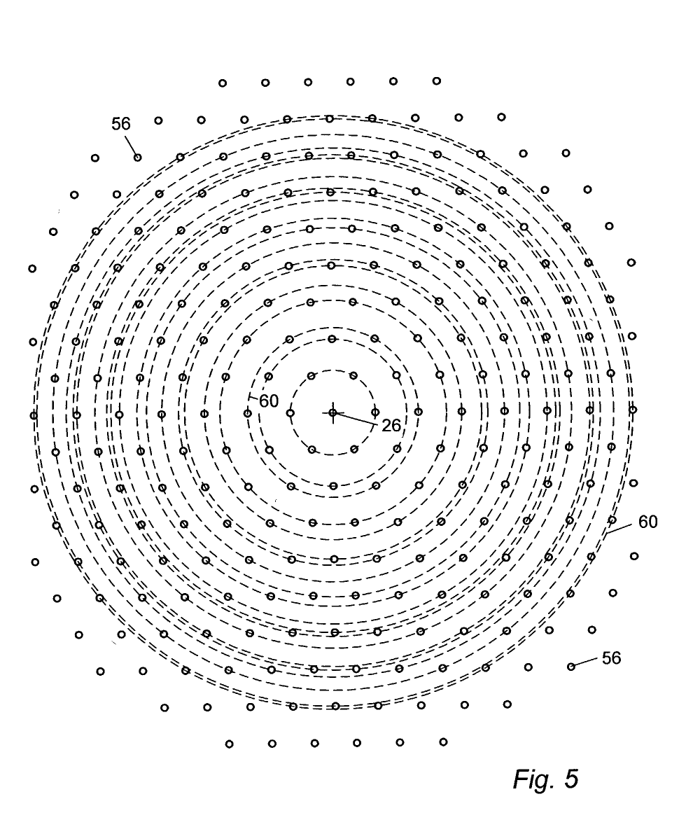

FIGS. 5-10 show various patterns that may be used to treat a volume of soil based on center 26 of an obstruction (obstructions not shown in FIGS. 5-10). A series of concentric circles, which are referred to as “orbits” 60, may be envisioned as encircling obstruction center 26. A center of each well 56 will be located substantially on one of orbits 60. An “annular thickness” is a radial distance from one orbit 60 to the next adjacent orbit. Ideally, a curved wall or edge of an obstruction will fit within an annular thickness without any wells 56 impinging on or close to the obstruction and without having to modify the regular well pattern. If the wall or edge will not fit within an annular thickness, then a substantially regular well pattern may be chosen that results from moving only a minimal number of wells 56 from the regular pattern.

Wells 56 positioned within an area that includes an arcuate obstruction may be located in orbits 60 around radial center 26 of the curve of the arcuate obstruction. A pattern of wells 56 may be a center well pattern, a center unit pattern, or a center side pattern, depending on the position of wells in the pattern relative to radial center 26 of curvature of the obstruction. Wells 56 may be located at or near radial center 26 of curvature of the obstruction (depending on the type of pattern), or imaginary wells may be located at or near the radial center of curvature of the obstruction. Imaginary wells may be utilized when a soil treatment area does not extend or include an area near the radial center of curvature of the obstruction. For example, if soil contamination is located on an outer side of a storage vessel that had a leak, a well pattern may be developed based on the radial center of the storage vessel. The well pattern may be based on the radial center of the storage vessel even though no wells would be placed within the storage vessel.

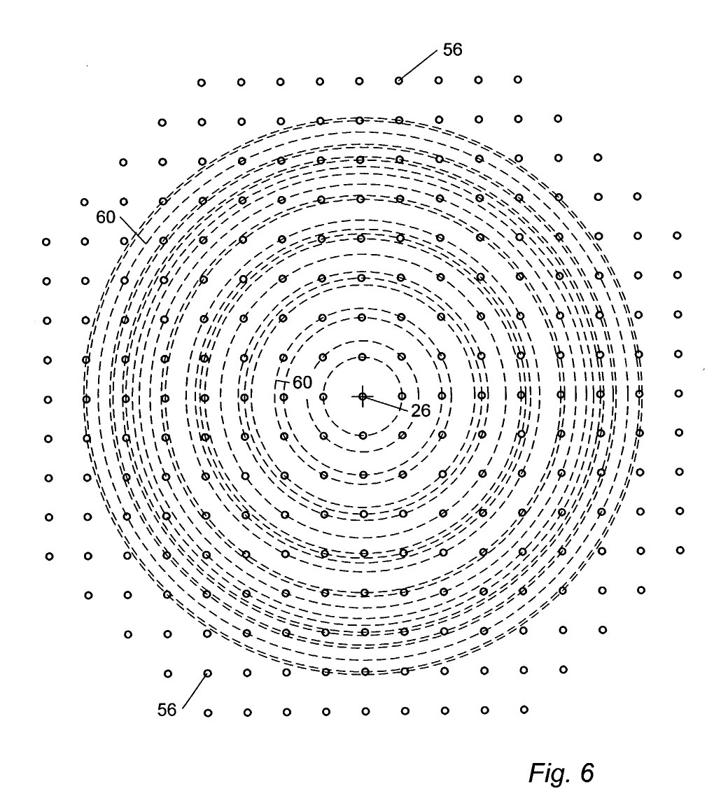

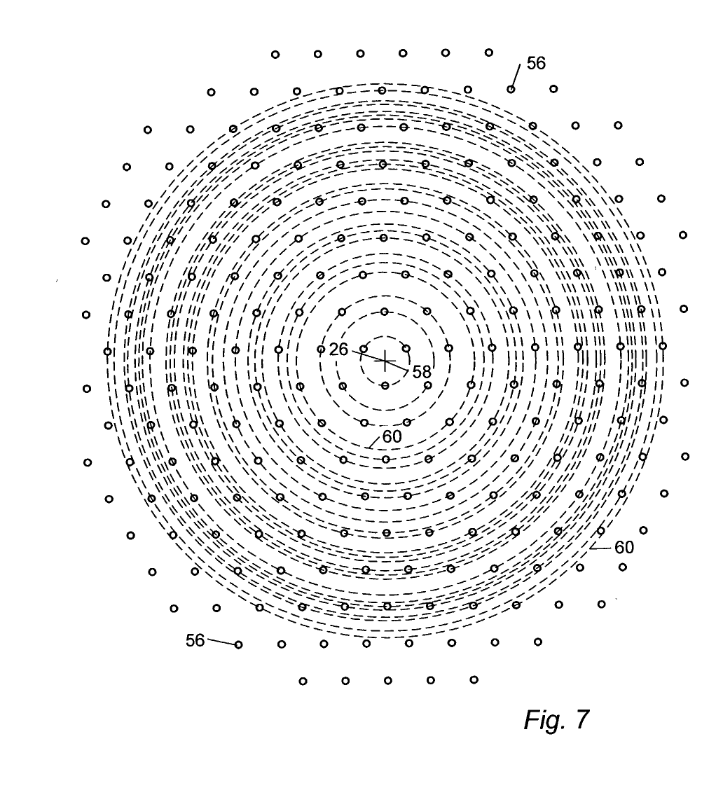

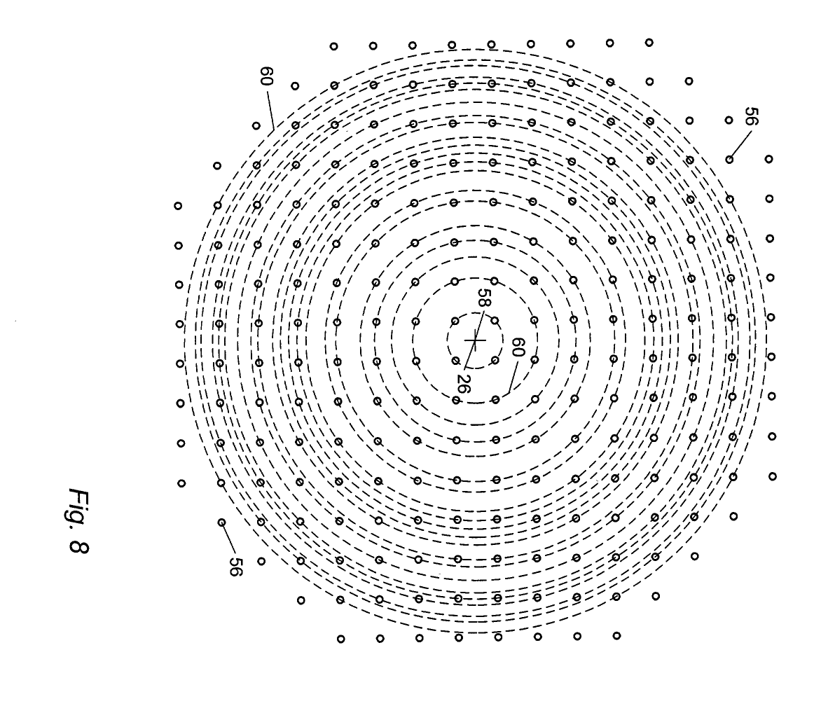

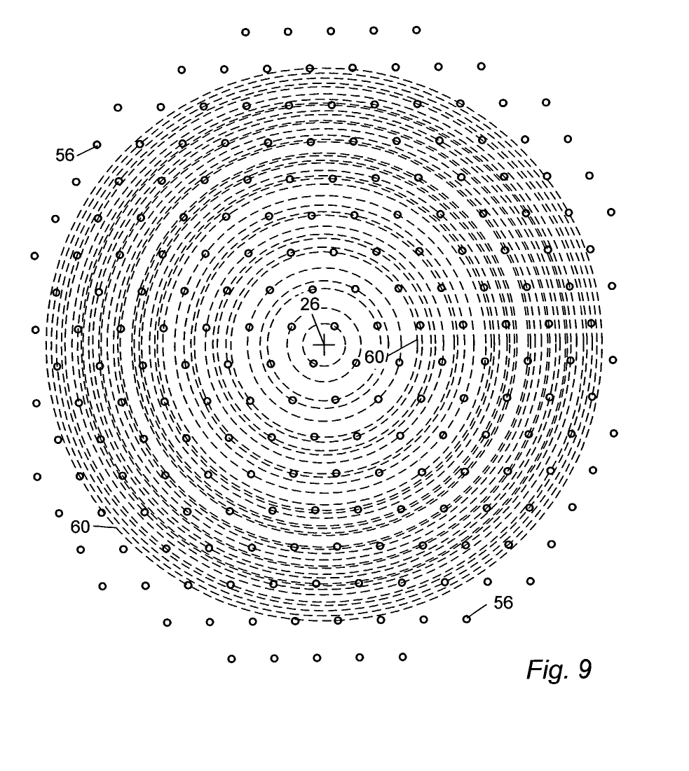

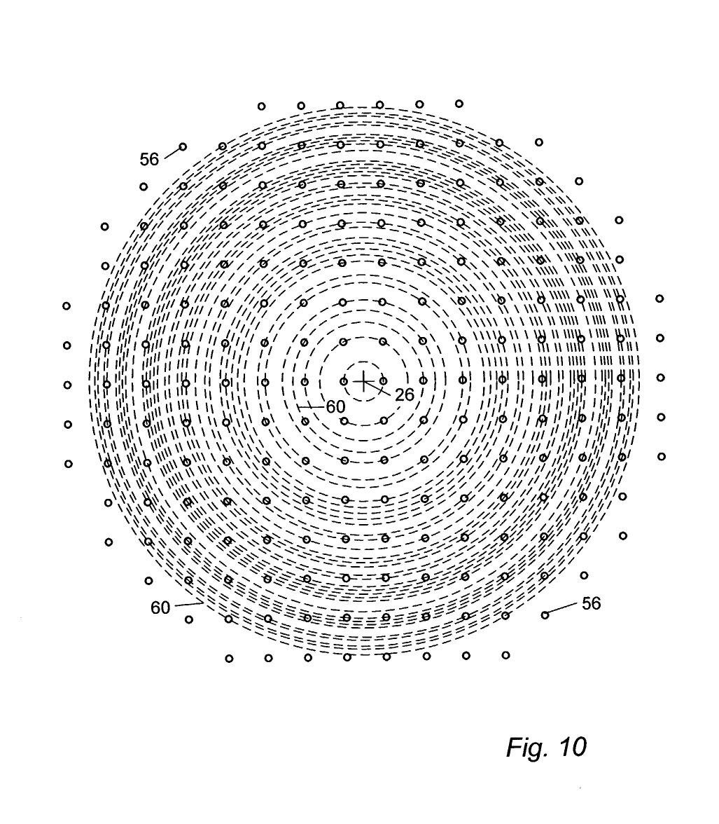

In an embodiment, wells 56 may be placed so that a well, or an imaginary well, is located substantially at obstruction center 26. FIG. 5 shows orbits 60 for a center well equilateral triangle pattern, and FIG. 6 shows orbits for a center well square pattern. In another embodiment, wells 56 may be placed so that centroid 58 of a unit, or an imaginary unit, of the well pattern is located substantially at obstruction center 26. FIG. 7 shows orbits 60 for a center unit equilateral triangle pattern, and FIG. 8 shows a center unit square pattern. In another embodiment, wells 56 may be placed so that obstruction center 26 is located at a center of a side between two wells of a unit, or of an imaginary unit, of the well pattern. FIG. 9 shows orbits 60 for a center side equilateral triangle pattern, and FIG. 10 shows orbits for a center side square pattern.

Tables 1-6 present data for the first thirty orbits 60 of each of the patterns shown in FIGS. 5-10. The data for the distance to the next orbit (annular thickness) and the data for the distance from obstruction center 26 in Tables 1-6 is normalized (divided by) a length of a side of a unit of the well pattern. FIGS. 5-10 show and Tables 1-6 indicate that large gaps may exist between two adjacent orbitals 60. A well pattern may be chosen for a soil remediation system so that a curved wall or edge of an obstruction is located primarily within a large gap between two orbitals 60. For example, a well pattern may be chosen so that an obstruction wall is positioned between the fourteenth and fifteenth orbitals of a center well equilateral triangle pattern. (See FIG. 5 and Table 1.) If the length of the side of the pattern is 6.5 feet and if the diameter of each well 56 is 0.75 feet, the obstruction wall could fit between orbits 60 if the wall was less than ((6.5)(0.432)−0.75)=2.06 feet.

FIGS. 5-10 and Tables 1-6 also show that the number of wells 56 in orbit 60 for a well pattern may vary. If wells 56 are placed inward of an obstruction, it is desirable to have a large number of wells in orbit 60 adjacent to the obstruction. Wells 56 in potential orbit 60 may have to be moved so that the wells are not placed within or too close to the obstruction. If wells 56 would be placed within or too close to the obstruction, the wells may be moved radially with respect to obstruction center 26. In some embodiments, wells that are to be moved may be moved in non-radial directions. Wells 56 of orbit 60 that need to be moved may be chosen so that only a few wells need to be moved.

For example, a 2.5 foot thick wall of a circular obstruction may be placed substantially within the annular thickness between the fourteenth and fifteenth orbits of a center well square pattern with a side length of 6.5 feet. (See FIG. 6 and Table 2.) To avoid having some wells 56 impinge in or be placed too close to the wall, some wells would need to be moved. There are sixteen wells 56 in the combined closely spaced thirteenth and fourteenth orbits and only eight wells in the fifteenth orbit, so the eight wells in the fifteenth orbit could be moved radially outward to avoid placing the wells in or close to the obstruction wall with little disruption of the regular well pattern. Similarly, if the wall or edge of the obstruction is placed substantially within the annular thickness between the nineteenth and twentieth orbits of a center well equilateral triangle pattern, the six wells of the nineteenth orbital may be moved inward to avoid placing wells 56 within or close to the obstruction. (See FIG. 5 and Table 1.) In some embodiments, wells or selected wells of an orbital may be omitted rather than being moved. Minor adjustments to correctly position orbits near the wall can be made by slightly changing the well spacing.

TABLE 1
Center Well Equilateral Triangle Pattern

| | # of | cum. | norm. dist | norm. dist |
|---|---|---|---|---|
| orbit | wells | wells | to next orbit | from center |
| 0 | 1 | 1 | 1 | |
| 1 | 6 | 7 | 0.732 | 1 |
| 2 | 6 | 13 | 0.268 | 1.732 |
| 3 | 6 | 19 | 0.646 | 2 |
| 4 | 12 | 31 | 0.354 | 2.646 |
| 5 | 6 | 37 | 0.464 | 3 |
| 6 | 6 | 43 | 0.141 | 3.464 |
| 7 | 12 | 55 | 0.394 | 3.605 |
| 8 | 6 | 61 | 0.356 | 4 |
| 9 | 12 | 73 | 0.224 | 4.356 |
| 10 | 12 | 85 | 0.417 | 4.58 |
| 11 | 6 | 91 | 0.196 | 5 |
| 12 | 6 | 97 | 0.095 | 5.196 |
| 13 | 12 | 109 | 0.276 | 5.291 |
| 14 | 12 | 121 | 0.432 | 5.567 |
| 15 | 6 | 127 | 0.083 | 6 |
| 16 | 12 | 139 | 0.162 | 6.083 |
| 17 | 12 | 151 | 0.312 | 6.245 |
| 18 | 12 | 163 | 0.371 | 6.557 |
| 19 | 6 | 169 | 0.072 | 6.928 |
| 20 | 18 | 187 | 0.211 | 7 |
| 21 | 12 | 199 | 0.339 | 7.211 |
| 22 | 12 | 211 | 0.26 | 7.55 |
| 23 | 12 | 223 | 0.127 | 7.81 |
| 24 | 12 | 235 | 0.063 | 7.937 |
| 25 | 6 | 241 | 0.188 | 8 |
| 26 | 12 | 253 | 0.357 | 8.188 |
| 27 | 12 | 265 | 0.174 | 8.544 |
| 28 | 6 | 271 | 0.116 | 8.660 |
| 29 | 12 | 283 | 0.058 | 8.719 |
| 30 | 12 | 295 | 0.170 | 8.888 |
| 31 | 6 | 301 | 0.165 | 9.000 |

TABLE 2
Center Well Square Pattern

| | # of | cum. | norm. dist | norm. dist |
|---|---|---|---|---|
| orbit | wells | wells | to next orbit | from center |
| 0 | 1 | 1 | 1 | |
| 1 | 4 | 5 | 0.414 | 1 |
| 2 | 4 | 9 | 0.589 | 1.414 |
| 3 | 4 | 13 | 0.236 | 2 |
| 4 | 8 | 21 | 0.592 | 2.236 |
| 5 | 4 | 25 | 0.172 | 2.828 |
| 6 | 4 | 29 | 0.162 | 3 |
| 7 | 8 | 37 | 0.443 | 3.162 |
| 8 | 8 | 45 | 0.394 | 3.605 |
| 9 | 4 | 49 | 0.123 | 3.999 |
| 10 | 8 | 57 | 0.12 | 4.122 |
| 11 | 4 | 61 | 0.23 | 4.242 |
| 12 | 8 | 69 | 0.528 | 4.472 |
| 13 | 12 | 81 | 0.099 | 5 |
| 14 | 8 | 89 | 0.286 | 5.099 |
| 15 | 8 | 97 | 0.272 | 5.385 |
| 16 | 4 | 101 | 0.174 | 5.657 |
| 17 | 8 | 109 | 0.169 | 5.831 |
| 18 | 4 | 113 | 0.083 | 6 |
| 19 | 8 | 121 | 0.242 | 6.083 |
| 20 | 8 | 129 | 0.079 | 6.325 |
| 21 | 8 | 137 | 0.305 | 6.404 |
| 22 | 8 | 145 | 0.292 | 6.709 |
| 23 | 4 | 149 | 0.071 | 7 |
| 24 | 12 | 161 | 0.14 | 7.071 |
| 25 | 8 | 169 | 0.069 | 7.211 |
| 26 | 8 | 177 | 0.336 | 7.28 |
| 27 | 8 | 185 | 0.195 | 7.616 |
| 28 | 8 | 193 | 0.19 | 7.811 |
| 29 | 4 | 197 | 0.062 | 8 |
| 30 | 16 | 213 | 0.184 | 8.062 |

TABLE 3
Center Unit Equilateral Triangle Pattern

| | # of | cum. | norm. dist | norm. dist |
|---|---|---|---|---|
| orbit | wells | wells | to next orbit | from center |
| 0 | 3 | 3 | 0.577 | 0.577 |
| 2 | 3 | 6 | 0.373 | 1.154 |
| 3 | 6 | 12 | 0.554 | 1.527 |
| 4 | 6 | 18 | 0.228 | 2.081 |
| 5 | 3 | 21 | 0.207 | 2.309 |
| 6 | 6 | 27 | 0.37 | 2.516 |
| 7 | 3 | 30 | 0.168 | 2.886 |
| 8 | 6 | 36 | 0.16 | 3.054 |
| 9 | 6 | 42 | 0.297 | 3.214 |
| 10 | 6 | 48 | 0.274 | 3.511 |
| 11 | 6 | 54 | 0.256 | 3.785 |
| 12 | 9 | 63 | 0.122 | 4.041 |
| 13 | 6 | 69 | 0.346 | 4.163 |
| 14 | 6 | 75 | 0.11 | 4.509 |
| 15 | 3 | 78 | 0.107 | 4.619 |
| 16 | 6 | 84 | 0.207 | 4.726 |
| 17 | 6 | 90 | 0.1 | 4.933 |
| 18 | 6 | 96 | 0.098 | 5.033 |
| 19 | 6 | 102 | 0.376 | 5.131 |
| 20 | 12 | 114 | 0.179 | 5.507 |
| 21 | 6 | 120 | 0.087 | 5.686 |
| 22 | 3 | 123 | 0.086 | 5.773 |
| 23 | 6 | 129 | 0.168 | 5.859 |
| 24 | 6 | 135 | 0.082 | 6.027 |
| 25 | 6 | 141 | 0.241 | 6.109 |
| 26 | 3 | 144 | 0.078 | 6.35 |
| 27 | 6 | 150 | 0.077 | 6.428 |
| 28 | 6 | 156 | 0.152 | 6.505 |
| 29 | 12 | 168 | 0.149 | 6.657 |
| 30 | 6 | 174 | 0.217 | 6.806 |

TABLE 4
Center Unit Square Pattern

| | # of | cum. | norm. dist | norm. dist |
|---|---|---|---|---|
| orbit | wells | wells | To next orbit | from center |
| 1 | 4 | 4 | 0.874 | 0.707 |
| 2 | 8 | 12 | 0.54 | 1.581 |
| 3 | 4 | 16 | 0.428 | 2.121 |
| 4 | 8 | 24 | 0.366 | 2.549 |
| 5 | 8 | 32 | 0.62 | 2.915 |
| 6 | 12 | 44 | 0.272 | 3.535 |
| 7 | 8 | 52 | 0.493 | 3.807 |
| 8 | 8 | 60 | 0.227 | 4.3 |
| 9 | 8 | 68 | 0.216 | 4.527 |
| 10 | 8 | 76 | 0.206 | 4.743 |
| 11 | 4 | 80 | 0.198 | 4.949 |
| 12 | 8 | 88 | 0.375 | 5.147 |
| 13 | 8 | 96 | 0.178 | 5.522 |
| 14 | 16 | 112 | 0.341 | 5.7 |
| 15 | 8 | 120 | 0.322 | 6.041 |
| 16 | 4 | 124 | 0.155 | 6.363 |
| 17 | 16 | 140 | 0.152 | 6.518 |
| 18 | 8 | 148 | 0.293 | 6.67 |
| 19 | 8 | 156 | 0.142 | 6.963 |
| 20 | 8 | 164 | 0.276 | 7.105 |
| 21 | 8 | 172 | 0.134 | 7.381 |
| 22 | 8 | 180 | 0.132 | 7.515 |
| 23 | 8 | 188 | 0.13 | 7.647 |
| 24 | 4 | 192 | 0.128 | 7.777 |
| 25 | 16 | 208 | 0.371 | 7.905 |
| 26 | 8 | 216 | 0.238 | 8.276 |
| 27 | 16 | 232 | 0.117 | 8.514 |
| 28 | 8 | 240 | 0.115 | 8.631 |
| 29 | 8 | 248 | 0.114 | 8.746 |
| 30 | 8 | 256 | 0.332 | 8.86 |

TABLE 5
Center Side Equilateral Triangle Pattern

| | # of | cum. | norm. dist | norm. dist |
|---|---|---|---|---|
| orbit | wells | wells | to next orbit | from center |
| 1 | 2 | 2 | 0.366 | 0.5 |
| 2 | 2 | 4 | 0.457 | 0.866 |
| 3 | 4 | 8 | 0.177 | 1.323 |
| 4 | 2 | 10 | 0.303 | 1.5 |
| 5 | 4 | 14 | 0.377 | 1.803 |
| 6 | 4 | 18 | 0.112 | 2.18 |
| 7 | 4 | 22 | 0.209 | 2.292 |
| 8 | 2 | 24 | 0.098 | 2.5 |
| 9 | 2 | 26 | 0.186 | 2.598 |
| 10 | 4 | 30 | 0.256 | 2.784 |
| 11 | 4 | 34 | 0.081 | 3.04 |
| 12 | 4 | 38 | 0.156 | 3.121 |
| 13 | 4 | 42 | 0.221 | 3.277 |
| 14 | 6 | 48 | 0.275 | 3.5 |
| 15 | 4 | 52 | 0.13 | 3.775 |
| 16 | 4 | 56 | 0.064 | 3.905 |
| 17 | 4 | 60 | 0.124 | 3.969 |
| 18 | 4 | 64 | 0.179 | 4.093 |
| 19 | 4 | 68 | 0.058 | 4.272 |
| 20 | 2 | 70 | 0.114 | 4.33 |
| 21 | 4 | 74 | 0.056 | 4.444 |
| 22 | 2 | 76 | 0.27 | 4.5 |
| 23 | 8 | 84 | 0.052 | 4.77 |
| 24 | 4 | 88 | 0.103 | 4.822 |
| 25 | 4 | 92 | 0.15 | 4.925 |
| 26 | 4 | 96 | 0.146 | 5.075 |
| 27 | 4 | 100 | 0.048 | 5.221 |
| 28 | 4 | 104 | 0.141 | 5.269 |
| 29 | 4 | 108 | 0.092 | 5.41 |
| 30 | 2 | 110 | 0.135 | 5.5 |

TABLE 6
Center Side Square Pattern

| | # of | cum. | norm. dist | norm. dist |
|---|---|---|---|---|
| orbit | wells | wells | to next orbit | from center |
| 1 | 2 | 2 | 0.618 | 0.5 |
| 2 | 4 | 6 | 0.382 | 1.118 |
| 3 | 2 | 8 | 0.303 | 1.5 |
| 4 | 4 | 12 | 0.259 | 1.803 |
| 5 | 6 | 18 | 0.438 | 2.062 |
| 6 | 4 | 22 | 0.193 | 2.5 |
| 7 | 4 | 26 | 0.349 | 2.693 |
| 8 | 4 | 30 | 0.16 | 3.042 |
| 9 | 4 | 34 | 0.153 | 3.202 |
| 10 | 4 | 38 | 0.146 | 3.355 |
| 11 | 2 | 40 | 0.14 | 3.501 |
| 12 | 4 | 44 | 0.265 | 3.641 |
| 13 | 4 | 48 | 0.126 | 3.906 |
| 14 | 8 | 56 | 0.241 | 4.032 |
| 15 | 4 | 60 | 0.228 | 4.273 |
| 16 | 2 | 62 | 0.11 | 4.501 |
| 17 | 8 | 70 | 0.107 | 4.611 |
| 18 | 4 | 74 | 0.207 | 4.718 |
| 19 | 4 | 78 | 0.101 | 4.925 |
| 20 | 4 | 82 | 0.195 | 5.026 |
| 21 | 4 | 86 | 0.095 | 5.221 |
| 22 | 4 | 90 | 0.093 | 5.316 |
| 23 | 4 | 94 | 0.092 | 5.409 |
| 24 | 2 | 96 | 0.09 | 5.501 |
| 25 | 8 | 104 | 0.262 | 5.591 |
| 26 | 4 | 108 | 0.168 | 5.853 |
| 27 | 8 | 116 | 0.083 | 6.021 |
| 28 | 4 | 120 | 0.081 | 6.104 |
| 29 | 4 | 124 | 0.08 | 6.185 |
| 30 | 4 | 128 | 0.235 | 6.265 |

A large gap between wells 56 of two adjacent orbits 60 may be formed by moving wells of two adjacent orbits outwards and inwards (radially or otherwise). Wells 56 in the outer orbit may be moved outward, and the wells of the inner orbit may be moved inward. For example, for a center unit equilateral triangle pattern (see FIG. 7 and Table 3), there is an annular thickness of 0.122 times a length of a side of a unit distance between the twelfth and thirteenth orbits. There is an annular thickness of 0.346 times the length of the side of the unit distance between the thirteenth and fourteenth orbits. The annular distance between the fourteenth and fifteenth orbits is 0.11 times the length of the side of the unit distance. The six wells in the thirteenth orbit may be moved inward toward the twelfth orbit, and the six wells in the fourteenth orbit may be moved outward toward the fifteenth orbit to form a gap (up to about 0.58 times the length of the side of the unit) that may accommodate a circular obstruction.

Wells 56 may be placed radially inward and outward of an obstruction with curved wall or edge. Wells 56 may be placed so that a large number of wells are located adjacent to the obstruction, both on an inward side and an outward side of the obstruction wall or edge. In some situations, it may only be desirable to treat soil on an inward side of an obstruction. In other situations, it may be desirable to treat soil only on an outward side of an obstruction.

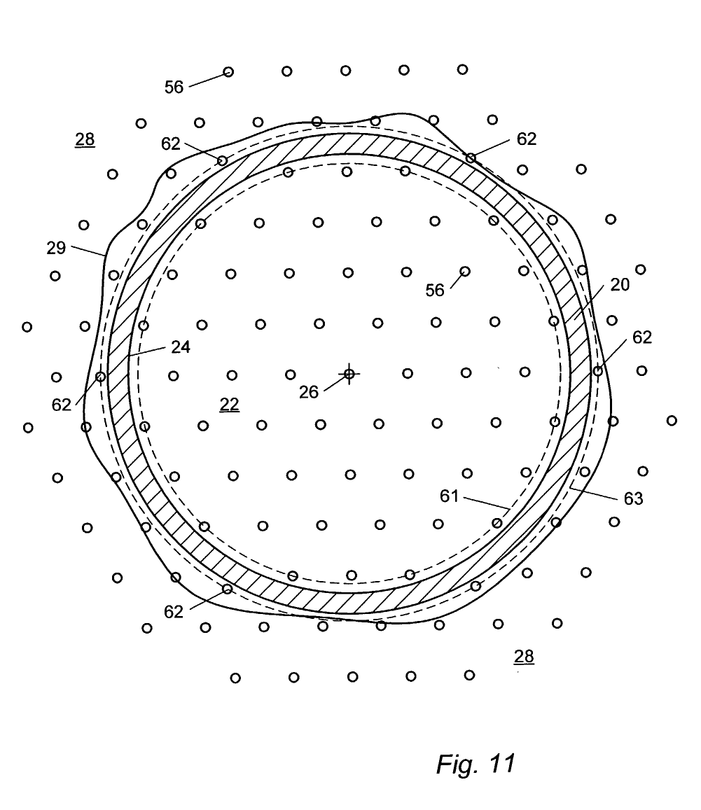

FIG. 11 shows an embodiment of a well pattern for treatment of soil contamination within and adjacent to circular obstruction 20. Circular obstruction 20 in the shown embodiment has a wall thickness of 2.167 feet, and an outer diameter of 50.8 feet. Circular obstruction 20 has a clay bottom. Soil within circular obstruction 20 may be contaminated to a depth of about 9 feet. A center well equilateral triangle pattern may be used to treat contaminated soil 22 within and surrounding circular obstruction 20. A side of a unit triangle may have a length of 6.167 feet. Wells 56 may be heater-extraction wells that are placed in 8 inch augered holes. The well pattern may allow circular obstruction wall 24 to be substantially positioned between seventh orbit 61 and eighth orbit 63 of the well pattern. Each of six wells 62 in the eighth orbit may be moved radially outward a length of about 1.5 feet to avoid placing these six wells 62 in circular obstruction wall 24. The well pattern shown in FIG. 11 has fifty-five wells 56 inside of circular obstruction 20, and sixty-four wells (including the six out-of-pattern wells 62) outside of the circular obstruction.

In some soil remediation embodiments, an entire volume of contaminated soil 22 may be treated at one time. In other embodiments, available power and a large number of wells 56 may make treating an entire volume of contaminated soil 22 at one time impractical. If treating an entire volume of contaminated soil 22 at one time is impractical, then sections of contaminated soil may be treated sequentially until the entire contaminated volume of soil is treated.

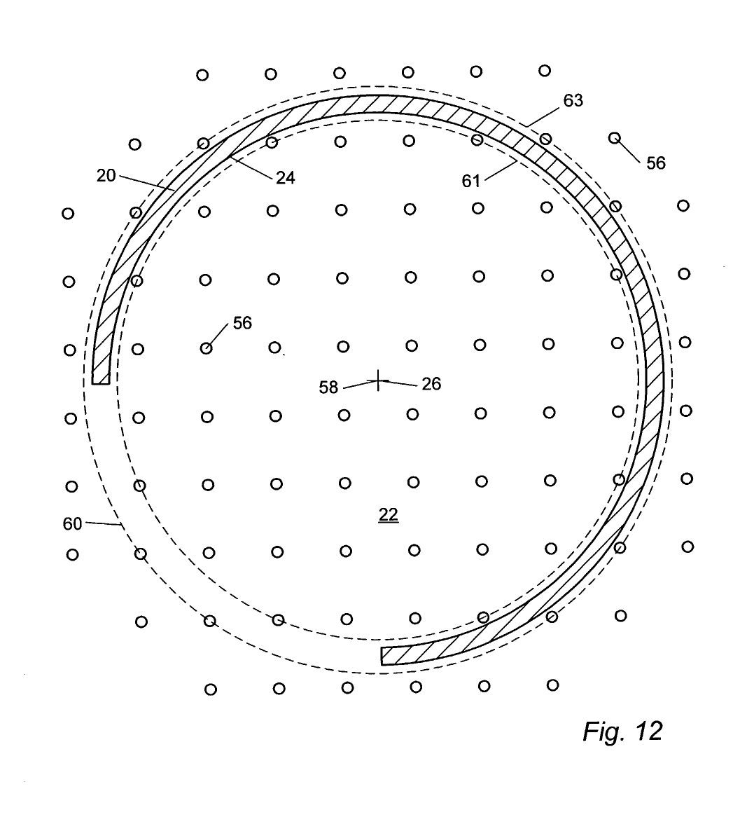

FIG. 12 shows a well pattern for treatment of soil contamination 22 within and adjacent to arcuate obstruction 20 using a center well square pattern. Obstruction wall 24 is placed in the annular thickness between seventh orbit 61 and eighth orbit 63 of the well pattern. For the well pattern embodiment shown in FIG. 12, no wells 56 needed to be moved from the regular well pattern to avoid placing a well in wall 24 of obstruction 20.

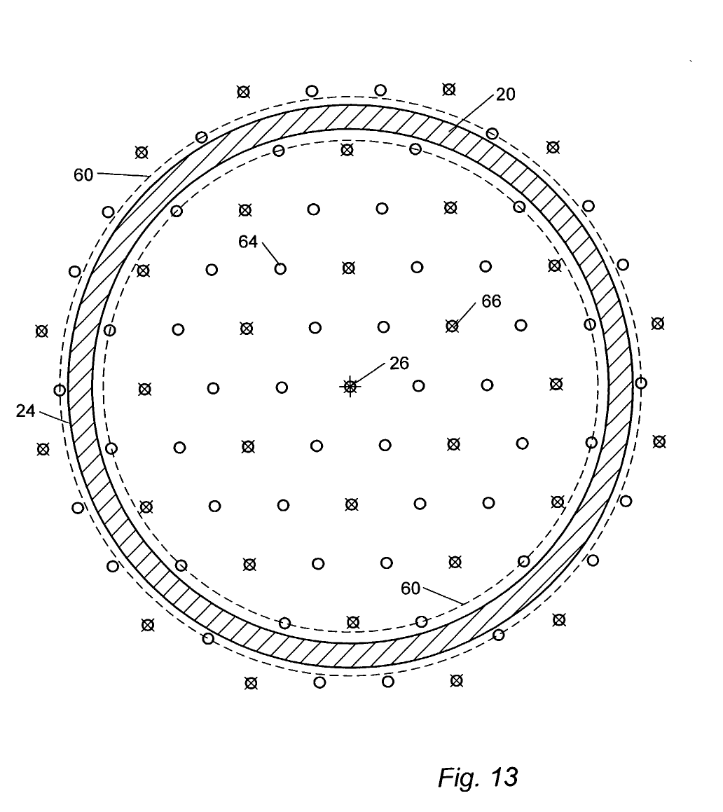

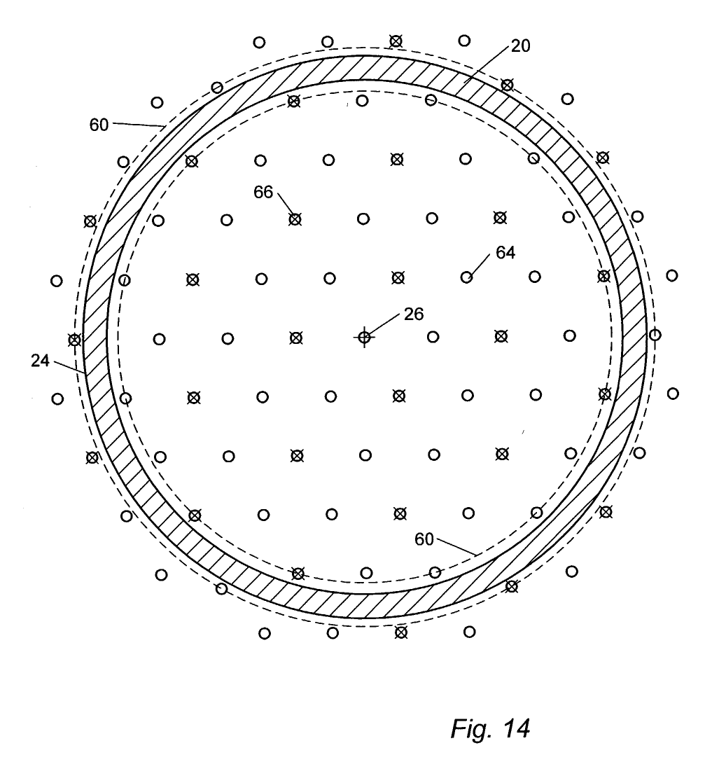

Wells 56 shown in FIG. 11 are heater-extraction wells. A well pattern may be implemented that uses a combination of different types of wells. For example, a well pattern with both heater-extraction wells and heater wells may be used. FIGS. 13 and 14 show patterns that use heater wells 64 and heater-extraction wells 66. The well layout of FIG. 13 may be advantageous, because the well pattern has higher symmetry than the well pattern of FIG. 14.

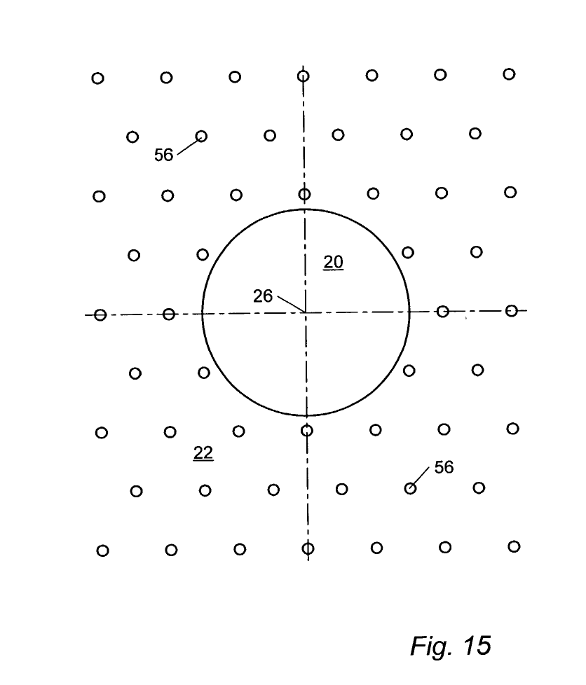

FIG. 15 shows an embodiment of a well pattern that may be used to treat contaminated soil 22 that is located radially outward of obstruction 20. Obstruction 20 may be a silo, tank, or other type of structure with no significant soil contamination 22 located beneath the structure. Although no wells 56 are to be placed within a perimeter defined by the outer edge of obstruction 20, the well pattern used to treat contaminated soil 22 may be located based upon center 26 of the obstruction.

To determine a well pattern to treat contaminated soil on both sides of an obstruction that includes a curved wall or edge with a thickness, a well planner may determine the center of the obstruction. The well planner may determine whether the pattern is to be a triangle pattern, a square pattern, or a higher order polygon pattern. The well planner may also determine whether the pattern is to be a center well pattern, a center unit pattern, or a center side pattern. The well planner may estimate a well spacing, which is the distance between wells of a unit of the well pattern. The well planner may determine an obstruction spacing for the obstruction. The obstruction spacing is the thickness of the wall or edge plus an offset distance needed to allow placement of a well near the obstruction.

The well planner may determine if a selected well spacing allows the obstruction spacing to be located primarily within an annular thickness between two adjacent orbits. If the well pattern allows the obstruction spacing to be contained within an annular thickness, the desired well pattern is determined. Wells may be placed within the soil according to the well pattern. The soil may be treated using a soil remediation system.

If the well pattern allows the obstruction spacing to contact one or two orbits, the well planner may decide to move the wells that will impinge upon the obstruction spacing inward and/or outward to avoid placement of the wells within the obstruction spacing. If the number of wells that would impinge the obstruction spacing is low, the well pattern may be useful for a soil remediation system. The wells would be placed in the contaminated soil according to the well pattern, with the wells that would impinge on the obstruction spacing moved inward and/or outward to avoid placement of the wells within the obstruction spacing. The soil may then be treated using the soil remediation system. If too many wells would need to be moved to avoid the obstruction spacing, different well spacings may be considered until a desirable well pattern is found.

If the well pattern allows the obstruction spacing to contact three or more orbits, the well planner may change the well spacing and/or the well pattern type until a well pattern is found that allows the placement of the wells so that few or no wells will impinge upon the obstruction spacing. If a few wells impinge upon the obstruction spacing, the wells may be moved outward or inward when the wells are placed within the contaminated soil. The well pattern may be chosen so that a large number of wells are located near outer and inner edges of the wall. Wells may be placed in the contaminated soil according to the well pattern, and the soil may be treated using a soil remediation system.

A well pattern based upon a center of an obstruction that includes an arcuate perimeter may be used to treat an area of contaminated soil that is only on one side of the obstruction. The contaminated soil may be located either inside or outside of the obstruction. FIG. 15 shows an embodiment of a well pattern that may be used to treat contaminated soil that is located outside of an obstruction. A well planner may determine the center of the obstruction. The well planner may determine whether the pattern is to be a square pattern or a triangle pattern. The well planner may also determine whether the pattern is to be a center well pattern, a center unit pattern, or a center side pattern. The well planner may estimate a well spacing, which is the distance between wells of a unit of the well pattern. The well spacing may be chosen so that a large number of wells will be adjacent to the wall when the wells are placed within the contaminated soil.

In some soil remediation embodiments, a barrier may be formed around a treatment area to define a specific volume of soil that is to be remediated. The barrier may include natural barriers, such as an overburden, an underburden, or other soil layer that is impermeable to fluid flow. A barrier may include installed barriers. Installed barriers may be, but are not limited to, interconnected sheets installed in the soil, grout walls, and/or freeze wells. U.S. Pat. No. 2,777,679 issued to Ljungström, which is incorporated by reference as if fully set forth herein, describes creating a frozen barrier to define a perimeter of a zone that is to be subjected to hydrocarbon production. Material within the zone is pyrolyzed by convectively advancing a heating front through the material to drive pyrolysis products toward production wells. U.S. Pat. No. 4,860,544 issued to Krieg et al., which is incorporated by reference as if fully set forth herein, describes establishing a closed cryogenic barrier confinement system about a predetermined volume extending downward from or beneath a surface region of Earth, i.e., a containment site. U.S. Provisional Application No. 60/343,637 entitled “Isolation Of Soil With A Frozen Barrier Prior To Conductive Thermal Treatment Of The Soil” by Harold J. Vinegar and George L. Stegemeier (filed on Oct. 24, 2001), which is incorporated by reference as if fully set forth herein, describes freeze wells and the use of freeze wells for soil remediation.

An advantage of establishing a well pattern for a soil remediation system relative to a center of an arcuate obstruction is that the well pattern may be chosen so that the wells do not contact a wall of the arcuate obstruction within the area to be treated, or so that the wells are at a desired minimum distance from the obstruction. Another advantage of selecting well placement relative to a center of a circular obstruction is that if a number of wells must be moved to avoid contacting the circular obstruction, the wells to be moved may be wells in an orbit that contains only a small number of wells. The small number of wells may allow for only a small deviation from a regular well pattern. The use of a well pattern based upon a radial center of an arcuate obstruction may allow for design and implementation of an economical and efficient soil remediation system. Further advantages of establishing a well pattern based on a radial center of a curved obstruction may include that the well pattern and the resulting soil remediation system are durable, simple, efficient, and reliable; yet the well pattern and the soil remediation system may be easy to install and use.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of remediating contaminated soil in a geographic area that includes at least one obstruction, wherein at least a portion of the obstruction is curved, comprising:
identifying a center of the curved portion of the obstruction;
identifying a pattern for remediation wells in the geographic area;
locating the pattern relative to the center of the curved portion of the obstruction;
identifying a distance between remediation wells in the pattern;
determining a plurality of circles around the center, wherein each circle contacts a well location for a plurality of wells, or is located at a selected distance relative to the plurality of wells;
determining annular thicknesses between adjacent circles, the annular thicknesses being the radial distance from each circle around the center to the next circle around the center;
determining an obstruction spacing, the obstruction spacing being a thickness of the obstruction plus a distance from the obstruction; and
using the annular thicknesses and the obstruction spacing to determine a location of the obstruction in the pattern.

2. The method of claim 1, wherein the pattern is a center well equilateral triangle pattern.

3. The method of claim 1, wherein the pattern is a center well square pattern.

4. The method of claim 1, wherein the pattern is a center unit equilateral triangle pattern.

5. The method of claim 1, wherein the pattern is a center unit square pattern.

6. The method of claim 1, wherein the pattern is a center side equilateral triangle pattern.

7. The method of claim 1, wherein the pattern is a center side square pattern.

8. The method of claim 1, further comprising selecting the distance so that the obstruction spacing fits within an annular thickness.

9. The method of claim 1, further comprising selecting the distance so that a single circle impinges upon the obstruction spacing.

10. The method of claim 9, wherein wells of the pattern that are on the circle that impinges the obstruction spacing are moved toward the center of the obstruction to avoid placing the wells of the pattern that are on the circle within the obstruction spacing.

11. The method of claim 9, wherein wells of the pattern that are on the circle that impinges the obstruction spacing are moved away from the center of the obstruction to avoid placing the wells of the pattern that are on the circle within the obstruction spacing.

12. The method of claim 1, further comprising selecting the distance so that an outer circle and an inner circle impinge upon the obstruction spacing.

13. The method of claim 12, wherein wells of the pattern that are on the outer circle are moved away from the center of the obstruction to avoid placing the wells that are on the outer circle within the obstruction spacing.

14. The method of claim 12, wherein wells of the pattern that are on the inner circle are moved toward the center of the obstruction to avoid placing the wells that are on the inner circle within the obstruction spacing.

15. The method of claim 1, further comprising placing wells in contaminated soil according to the pattern.

16. The method of claim 15, further comprising treating the soil by removing off-gas from the wells.

17. The method of claim 15, further comprising treating the soil by applying heat to the soil through the wells.

18. A method of remediating contaminated soil within a region that includes an obstruction having an arcuate edge, comprising:
placing a plurality of wells in the contaminated soil in a pattern based upon a center of the arcuate edge, wherein the wells of the pattern do not contact the arcuate edge of the obstruction; and
extracting contaminants from the soil through the wells.

19. The method of claim 18, further comprising applying heat to the soil through at least one well.

20. The method of claim 18, wherein the wells are extraction wells, heater wells, or heater-extraction wells.

21. The method of claim 18, wherein the pattern is substantially a center well equilateral triangle pattern.

22. The method of claim 18, wherein the pattern is substantially a center unit equilateral triangle pattern.

23. The method of claim 18, wherein the pattern is substantially a center side equilateral triangle pattern.

24. The method of claim 18, wherein the pattern is substantially a center well square pattern.

25. The method of claim 18, wherein the pattern is substantially a center unit square pattern.

26. The method of claim 18, wherein the pattern is substantially a center side square pattern.

27. A system for remediating contaminated soil within a region that includes an obstruction having an arcuate edge, comprising:
a plurality of wells within the soil, the wells placed within the soil in a pattern wherein the wells of the pattern are positioned relative to a center of the arcuate edge, and wherein the wells of the pattern do not contact the arcuate edge of the obstruction;
vapor collection piping coupled to at least one of the plurality of wells; and
a treatment facility coupled to the collection piping, wherein the treatment facility is configured to draw a vacuum that removes contaminants from the soil through the wells and wherein the treatment facility is configured to process contaminants removed from the soil by the vacuum.

28. The system of claim 27, wherein the wells are extraction wells, heater wells, or heater-extraction wells.

29. The system of claim 27, wherein the pattern of wells is substantially a center well equilateral triangle pattern.

30. The system of claim 27, wherein the pattern of wells is substantially a center unit equilateral triangle pattern.

31. The system of claim 27, wherein the pattern of wells is substantially a center side equilateral triangle pattern.

32. The system of claim 27, wherein the pattern of wells is substantially a center well square pattern.

33. The system of claim 27, wherein the pattern of wells is substantially a center unit square pattern.

34. The system of claim 27, wherein the pattern of wells is substantially a center side square pattern.
